(19) United States
(12) Patent Application Publication
(10) Pub. No.: US 2003/0003291 A1
(43) Pub. Date: Jan. 2, 2003

(54) Foamed thermoplastic resin having fiber reinforcing and apparatuses for making

(76) Inventors: Suresh D. Shah, Troy, MI (US); Edward J. Wenzel, Troy, MI (US); Mike W. Jary, Farmington Hills, MI (US); Chad A. Bengry, Rochester Hills, MI (US)

Correspondence Address: CHUCK VEENSTRA, ESQ., DELPHI TECHNOLOGIES, INC., P.O. Box 5052, Mail Code: 480-414-420, Troy, MI, 48007-5052, US

(21) Appl. No.: 10/173,377

(22) Filed: Jun. 17, 2002

Related U.S. Application Data
(60) Provisional application No. 60/302,471, filed on Jul. 2, 2001.

(51) Int. Cl. B28B 13/00; B29C 31/04; B29C 63/00; B32B 5/20; B32B 3/00; B29C 44/42

(52) U.S. Cl. 428/317.9; 425/4 R; 425/130; 425/256; 428/314.8; 428/315.7; 428/318.6; 428/318.8; 428/319.7

(57) ABSTRACT

A foamed thermoplastic resin fiber reinforced part is provided. The part comprises a member formed of thermoplastic resin, a plurality of cells and a plurality of reinforcing fibers dispersed within the member, and a skin formed on at least one exterior surface of the member. The skin is substantially devoid of cells. Here, the reinforcing fibers have a length of about 25 mm in an amount of about 10% by weight of the foamed thermoplastic resin fiber reinforced part. At least one of a cell density and a cell size of the plurality of cells is inversely proportional to the amount of the reinforcing fibers dispersed within the member.

### RELATED APPLICATIONS

This application claims the benefit of provisional application serial number 60/302,471 filed on Jul. 2, 2001, the contents of which are incorporated herein in their entirety. This application is also related to commonly owned and assigned U.S. patent application Ser. No. 09/473,279 entitled “An In-Line Compounding Extrusion Deposition And Molding Apparatus And Method Of Using The Same” filed on Dec. 28, 1999, the contents of which are incorporated herein by reference thereto.

### BACKGROUND

This disclosure relates generally to a part of foamed thermoplastic resin having fiber reinforcing, as well as apparatuses for making such parts.

It is common to reinforce thermoplastic resin structures with fibrous materials. The fibers typically have mechanical properties that are superior to properties of the thermoplastic resin. Thus, such fiber reinforcing is beneficial because it increases the strength of the resulting structure or part.

Thermoplastic resin structures reinforced with fibers have been manufactured using several different methods. For example, such parts have been made using the so-called pultrusion method. Here, a thermoplastic resin is impregnated into a continuous reinforcement fiber bundle. The bundle is subsequently passed through a crosshead extrusion die. After undergoing the pultrusion method, the structures are cut to a desired size. Alternately, such parts have been made by melting thermoplastic resin in a single screw extruder. The melted resin is fed to a second single screw extruder where chopped fibers are fed into the melt. This reinforced melt is pumped into an accumulator after which the required log size is cut and fed into a vertical molding press. However, these prior methods do not employ a desired a single-step process of reinforcing the long fibers and molding the part in the same step.

Single-steps methods have also been used to produce fiber reinforced structures. However, these methods require the fiber to be incorporated into the resin pellets. Thus, the length of the reinforcing agents is limited by the size of the pellet. Further, introduction of reinforcing agents is known to increase the viscosity of the melt. Thus, introduction of the reinforcing agents as part of the resin pellets reduces the volume of reinforcing agents that can be added, which limits the overall strength increases that can be achieved from the resultant thermoplastic resin parts. Thus, the single step methods do not provide structures having the desired strength to weight characteristics.

One method of reducing the weight of thermoplastic resin structures is to form the structure of foamed polymer. Such foamed polymer parts include a plurality of cells or voids formed therein. By replacing solid polymer parts with foamed polymer parts, less raw material is necessary for identical parts of a given volume. However, the overall strength of the foamed polymer parts is somewhat less than that of identical solid polymer parts.

Accordingly, it is desired to provide parts having reinforcing fibers of long length in a foamed polymer. However, prior apparatus and methods are not fully effective at producing thermoplastic resins parts having both a foamed structure and long fiber reinforcements. Further, prior apparatus and methods are not fully effective in employing a single-step process.

It has been determined that thermoplastic resins parts having both a foamed structure and long fiber reinforcements can be produced using the exemplary apparatuses of the present disclosure.

### SUMMARY

A foamed thermoplastic resin fiber reinforced part is provided. The part comprises a member formed of thermoplastic resin, a plurality of cells and a plurality of reinforcing fibers dispersed within the member, and a skin formed on at least one exterior surface of the member. The skin is substantially devoid of cells. Here, the reinforcing fibers have a length of at least about 25 millimeters (mm) in an amount of at least about 10% by weight of the foamed thermoplastic resin fiber reinforced part. At least one of a cell density and a cell size of the plurality of cells is inversely proportional to the amount of the reinforcing fibers dispersed within the member.

An apparatus for producing a foamed fiber reinforced part is provided. The apparatus comprises a barrel, three inlets, and a screw. The first inlet feeds a thermoplastic material into the barrel. The second inlet is downstream of the first inlet, and feeds reinforcing fibers into the barrel. The second inlet has a tensioning reel for feeding the reinforcing fibers under a constant tension. The third inlet is downstream of the second inlet, and injects a blowing agent into the barrel. The screw is rotatably disposed within the barrel such that a first zone, a second zone, and a third zone of said barrel are defined. The first zone melts the thermoplastic material, the second zone shears the reinforcing fibers to a predetermined length to form a first melt from the thermoplastic material and the reinforcing fibers. The third zone forms a second melt from the first melt and the blowing agent. The third zone maintains the second melt under a first condition sufficient to maintain the blowing agent in a desired form. The conditions on the second melt are changed to a second condition sufficient to cause the blowing agent to form cells in the second melt when it is forced from the barrel.

An apparatus for producing a foamed fiber reinforced part is also provided. The apparatus comprises an extrusion machine, an injection machine, and a mold in fluid communication with one another. The extrusion machine has twin-screw extruder in fluid communication with a first inlet, a second inlet, and a third inlet. The first inlet introduces a thermoplastic resin to the twin-screw extruder. The second inlet introduces reinforcing fibers to the twin-screw extruder so that the twin-screw extruder forms a first melt. The third inlet injects a blowing agent into the sealed section. A sealed section is defined at the third inlet. The twin-screw extruder forms a second melt from the first melt at a first condition. The injection machine receives the second melt from the sealed section and injects the second melt into the mold. The injection machine changes the first conditions to second conditions that are sufficient to cause the blowing agent to form a plurality of cells in the second melt when the second melt is injected into the mold.

The above described and other features are exemplified by the following figures, detailed description, and claims.

### BRIEF DESCRIPTION OF THE DRAWINGS

Referring now to the figures, which are exemplary embodiments, and wherein the like elements are numbered alike:

FIG. 1 is a sectional view of an exemplary embodiment of a foamed fiber reinforced part;

FIG. 2 is a schematic depiction of an exemplary embodiment of an apparatus for producing the foamed fiber reinforced part of FIG. 1;

FIG. 3 is cross-sectional view of an alternate embodiment of an apparatus for producing the foamed fiber reinforced part of FIG. 1 in a first position; and

FIG. 4 illustrates the apparatus of FIG. 3 in a second position.

### DETAILED DESCRIPTION

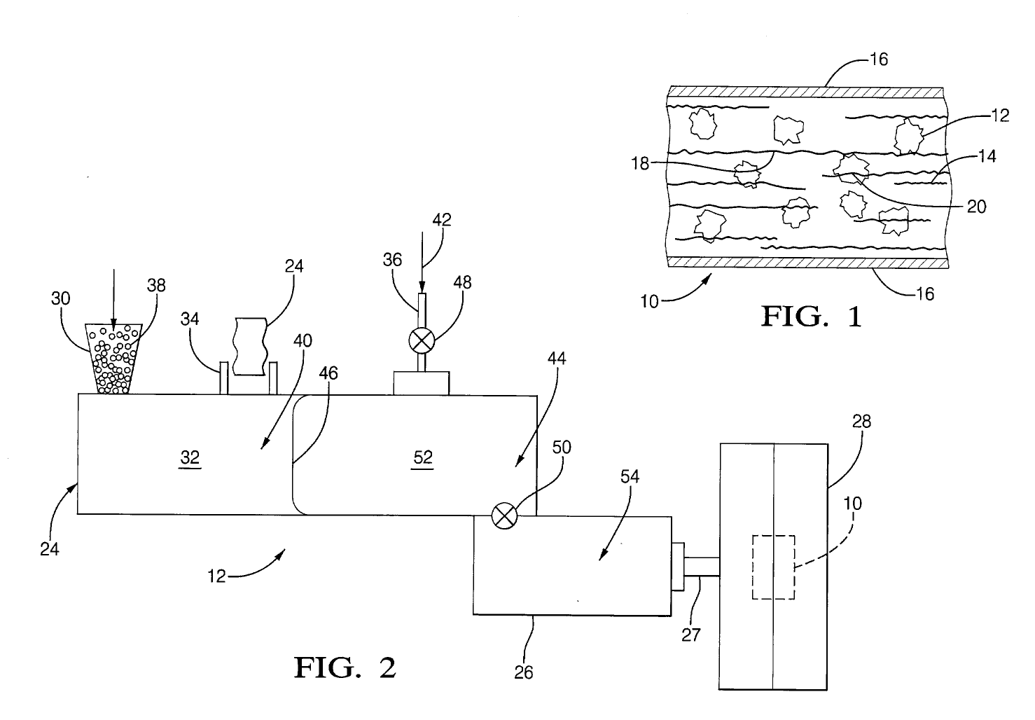

Referring now to FIG. 1, an exemplary embodiment of a foamed polymer fiber reinforced part 10 made in accordance with the present disclosure is shown. The part 10 comprises a plurality of cells 12 and a plurality of reinforcing fibers 14 dispersed in a thermoplastic resin material. Preferably, the cells 12 are closed cells. In an alternate exemplary embodiment, the part 10 further comprises a skin 16 formed on at least one of the exterior surfaces of the part 10. The skin 16 is substantially devoid of cells 12. Preferably, the skin 16 is formed on all of the exterior surfaces of the part 10.

The incorporation of fibers 14 into the part 10 increases the strength of the part. The fibers 14 increase the strength of the part 10 when dispersed in or wetted by the thermoplastic resin. The fibers 14 that are dispersed in the thermoplastic resin are referred to herein as wetted fibers 18.

The incorporation of the cells 12 into the part decreases the density of the part, which in turn reduces the amount of thermoplastic resin material necessary to make a part of a given size. The cells 12 are voids in the thermoplastic resin of the part 10. Thus, these cells 12 can reduce the number of wetted fibers 18 present. Namely, un-wetted fibers 20 are formed in the areas where the fibers 14 are disposed in and/or across a portion of a cell 12.

In the present disclosure, the part 10 is manufactured to ensure that the number of wetted fibers 18 is maximized, while the number of un-wetted fibers 20 is minimized. Namely, the agents used to form the cells 12 help to maximize the number of wetted fibers 18. The agents used to form the cells 12 reduce the viscosity of the polymer during the manufacture of the part. By reducing the viscosity, the fibers are more easily wetted by the polymer.

When it is desired to produce the part 10 having a high number of the fibers 14, the density and/or size of the cells 12 dispersed therein can be reduced. Conversely, when it is desired to produce the part 10 having a high density of the cells 12 and/or cells of larger size dispersed therein, the number of fibers 14 dispersed therein can be reduced. In this manner, the apparatus 22 is further configured to produce the part 10 having a maximum number of wetted fibers 18 and a minimum number of un-wetted fibers 20.

The part 10 is illustrated in FIG. 1 for purposes of clarity only as including the fibers 14 aligned with the axis of the part. Of course, the fibers 14 being randomly dispersed in the part 10 are contemplated.

Accordingly, the part 10 finds use in all applications where thermoplastic resin parts having a high strength-to-weight ratio are found. For example, automotive, aerospace, commercial or military aircraft industries, locomotive industries, and the like. Particularly, the part 10 finds use is automotive uses such as instrument panels, glove boxes, semi-structural instrument panel retainers, interior trim, and the like.

Generally, polymeric foams have been formed through the incorporation of physical blowing agents, chemical blowing agents, supercritical fluids, combinations of any of the foregoing and others into a polymer matrix. The blowing agent is mixed with a polymer to form a substantially homogeneous mixture of the blowing agent in the melt. The blowing agent can be introduced into molten polymer in a molding machine, can be introduced with the resin in the hopper of the molding machine, can be incorporated as part of the resin, and combinations of any of the foregoing.

By way of example only, chemical blowing agents can be an inert agent, such as CO₂, N₂, or other inert gas. The agent and the melt are mixed at first conditions (usually high pressures) so that the agent mixes with melt. In some instances, the blowing agent can be a supercritical fluid that is solublized in the polymer melt at the first conditions (e.g., high pressure and temperature) in order to create a substantially homogeneous single-phase solution.

The first conditions are maintained until the formation of the cells is desired. Foaming, in turn, can be accomplished by changing the first conditions to second conditions (usually ambient pressures). The change from the first to the second conditions causes the agent to expand, forming bubbles in the melt. This change in conditions (from the first to the second) can be a change in temperature, a change in pressure, or combinations thereof.

The melt is injected into a mold while at the second conditions or while the conditions are being changed to the second conditions. The mold is cooled to return the melt to a solid state, which forms the cover. The bubbles formed by the agent in the melt result in the cells or hollows being formed in the cover. It is known to form foamed polymers having cells of less than about 10 microns in diameter, known as micro cellular materials.

As the mold is cooled, the heat removed from the portion of the melt in contact with the mold causes the agent in that portion to contract such that a skin is formed on the surface of the finished part. The skin is substantially free of the cells or hollows. The thickness of the skin is dependent upon how rapidly the heat is removed from the surfaces of the melt that are in contact with the mold. During normal molding cycle times and temperatures, the skin is formed having a minimum thickness of about 0.0002 inches. However, the thickness of the skin can be increased by removing the heat from the melt more rapidly. Alternately, the thickness of the skin can be decreased by slowing the removal of heat from the melt.

Of course, it should be recognized that the process for forming a foamed polymer is described above by way of example only. Other methods of forming a foamed polymer are contemplated. Accordingly, any method for forming the cells. Turning now to FIGS. 2-4, exemplary embodiments of molding apparatus for the manufacture of the part 10 are illustrated. Of course, it should be recognized that alternate molding apparatus for the manufacture of the part 10 are illustrated. For example, part 10 can be injection molded, injection compression molded, extrusion compression molded, extrusion deposition compression molded, and the like.

Referring now to FIG. 2, a first exemplary embodiment of an apparatus 22 is illustrated. The apparatus 22 is configured to form the foamed fiber reinforced part 10. The apparatus 22 comprises an extrusion machine 24, an injection machine 26, and a mold 28. The extrusion machine 24 comprises a raw material inlet 30, a twin-screw extruder 32, a reinforcing fiber inlet 34, and a blowing agent inlet 36. Of course, it should be recognized that in alternate embodiments, the raw material inlet 30 can is also configured to have the blowing agent introduced at the raw material inlet.

The raw material inlet 30 is configured to introduce a thermoplastic resin 38 into the extrusion machine 24. Here, the thermoplastic resin 38 is in contact with the twin-screw extruder 32. The twin-screw extruder 32 is configured to melt the thermoplastic resin 38. The thermoplastic resin 38 is any thermoplastic material suitable for the part 10. For example, thermoplastic resins 38 comprising polypropylene, engineering thermoplastics such as polyester, nylon, polycarbonate, and TPV and TPE based elastomers, and combinations of any of the foregoing. In the event the thermoplastic resin 38 is hygroscopic, a dryer can be used to remove moisture before the resin enters the extrusion machine 24.

The reinforcing fiber inlet 34 is configured to introduce the fibers 14 into the molten or semi-molten thermoplastic resin 38. The twin-screw extruder 32 is configured to mix the thermoplastic resin 38 and the fibers 14 to form a fiber/resin melt 40. The fibers 14 are any fiber material suitable for the part 10, such as but not limited to glass fibers, natural fibers, polyaramid fibers (e.g., Kevlar fibers commercially available from DuPont), carbon fibers, and combinations of any of the foregoing.

As discussed above, prior methods of making reinforced fiber parts introduced the fibers to the extrusion machine by incorporating the fibers into the resin, which limits the maximum length of the fibers to about 8 millimeters (mm) because of the pellet size. It has been determined that feeding the fibers 14 into the extrusion machine 24 at the fiber inlet 34 (e.g., downstream of the inlet 30) allows for fibers having a longer length than previously possible to be incorporated into the part. For example, the apparatus 22 is configured to provide the part 10 with fibers 14 having of a length of at least about 25 mm, and up to about 100 mm. Accordingly, the apparatus 22 enables the manufacture of the part 10 having fibers 14 that are significantly longer than possible from prior machines/methods.

In a first exemplary embodiment, the fibers 14 are fed into the extrusion machine 24 at the fiber inlet 34 as chopped fibers. Here, the fibers 14 are individual fibers, bundles of fibers, and/or combinations thereof. By introducing chopped fibers 14 into the extrusion machine 24, the extruder 32 aids in the dispersion of the fibers in the resin 38 as randomly oriented reinforcing fibers. Parts 10 having randomly oriented reinforcing fibers 14 can be formed, depending on gating and part design, having isotropic properties. Namely, the part 10 exhibits equal strength when measured along all axes of the part. It has also been determined that the foaming of the part 10 can aid in the isotropic dispersion of fibers.

In an alternate exemplary embodiment, the fibers 14 are fed into the extrusion machine 24 at the fiber inlet 34 as continuous elongated fibers. Here, the fibers 14 are drawn into the extrusion machine 24 as individual fibers, bundles of fibers, and/or combinations thereof. By drawing the continuous fibers 14 into the thermoplastic resin 38, the fibers are dispersed in the resin such that they are substantially oriented along the axis of the extrusion machine 24. The fibers 14 can be preheated and/or pre-stretched to open up the bundle for improved wetting. Parts 10 having such substantially oriented reinforcing fibers 14 exhibit non-isotropic properties. Namely, the part 10 exhibits unequal strength when measured along the different axes of the part. In sum, the non-isotropic part exhibits greater strength in the direction of the fibers 14 as compared to the direction normal to the fibers.

The agent inlet 36 is configured to introduce a blowing agent 42 into the fiber/resin melt 40. The twin-screw extruder 32 is configured to admix the fiber/resin melt 40 with the blowing agent 42 to form a fiber/resin/agent melt 44.

In an exemplary embodiment, the extrusion machine 24 comprises a sealing element 46, an inlet valve 48, and an outlet valve 50. The sealing element 46 is disposed about the twin-screw extruder 32 between the fiber inlet 34 and the agent inlet 36. The inlet valve 48 seals the extrusion machine 24 at the agent inlet 36. The outlet valve 50 seals the outlet of the extrusion machine 24 from the injection machine 26. Thus, a sealed section 52 of the extrusion machine 24 is defined by the sealing element 46, and the valves 48 and 50.

The blowing agent 42 is introduced into the sealed section 52 at the agent inlet 36 by opening the inlet valve 48, while the outlet valve 50 is open. The sealed section 52 is maintained at first or supercritical conditions (e.g., elevated pressure and appropriate temperatures) where the agent 42 is in a liquid form. The sealing element 46 is configured to permit the flow of the fiber/resin melt 40 into the sealed section 52. However, the sealing element 46 prevents the flow of the fiber/resin/agent melt 44 back towards the inlets 32 and 34. The sealed section 52 is maintained at first conditions sufficient to maintain the blowing agent 42 in a liquid form.

After the agent 42 is injected into the fiber/resin melt 40, the inlet valve 48 is closed. The twin-screw extruder 32 admixes the liquid blowing agent 42 such that the fiber/resin/agent melt 44 is a substantially homogeneous mixture of the blowing agent in the melt. The fiber/resin/agent melt 44 is maintained at the first conditions until the formation of the cells 12 is desired.

The outlet valve 50 is opened to transfer the melt 44 into the injection machine 26. With the outlet valve 50 open, the twin-screw extruder 32 advances the fiber/resin/agent melt 44 into the injection machine 26 until a shot 54 of a desired quantity accumulates therein. The injection machine 26 includes a plunger 27 that is movable disposed within the injection machine. Initially, the plunger is in a first or retracted position (e.g., remote from the mold 28). Once the shot 54 has accumulated in the injection machine 26, the inlet valve 48 and the outlet valve 50 are closed and the twin-screw extruder 32 stops. The injection machine 26 moves the plunger 27 from the first position to a second position (e.g., proximate to the mold 28) to inject the shot 54 into the mold 28 where the mold forms the part 10 into the desired shape.

When the formation of the cells 12 is desired, the first conditions will be adjusted to second conditions. As will be described in more detail below, the change from the first to the second conditions can occur at several different points in the process. The second conditions are sufficient to convert the agent 42 from the liquid form to a gaseous form. For example, the pressure is reduced from the first conditions to the second conditions.

The gaseous agent 42 expands and forms bubbles in the melt 44, which forms the cells 12 in the part 10. This change in conditions (from the first to the second condition) changes the blowing agent to a gas by subjecting the mixture to for example, a rapid change in temperature, a rapid change in pressure, or combinations thereof. It is known to form foamed polymers having cells 12 of less than about 10 microns in diameter (e.g., micro cellular materials).

The mold 28 is initially in a closed position. The injection machine 26 injects the shot 54 into the closed mold 28 by moving the plunger 27 from the first to the second position. The mold 28 is cooled, and the part 10 is ejected. Meanwhile, the injection machine 26 retracts the plunger 27 as the outlet valve 50 is re-opened and the twin-screw extruder 32 re-starts to repeat the process. At this time, the shut off valve is closed and outlet valve 50 is open.

The mold 28 is cooled to return the thermoplastic resin 38 to a solid or non-molten state prior to being removed from the mold. As the mold 28 is cooled, the heat removed from the portion of the thermoplastic resin 38 in contact with the mold 28. This causes the gaseous agent 42 in the portion of the resin 38 in contact with the mold 28 to contract such that substantially no cells 12 are formed on the surface of the part 10. Namely, the part 10 is formed having the skin 16 on its surfaces in contact with the mold 28, wherein the skin does not include cells 12.

While in the sealed section 52, the injection machine 26, the mold 28, and combinations thereof, the first conditions on the melt 44/shot 54 are changed to the second conditions to allow the liquid agent 42 to convert to a gas and expand to form the cells 12. In a preferred embodiment, the first conditions are changed to the second conditions during the injection of the shot 54 from the injection machine 26 to the mold 28.

As discussed above, the addition of the fibers 14 increases the viscosity of the fiber/resin melt 40. The extrusion machine 24 typically has a maximum viscosity level beyond which it can no longer function effectively. This maximum viscosity level sets a limit on the total amount of fibers 14 that can be introduced to the extrusion machine 24. Thus, this maximum viscosity level sets a limit on the total amount of fibers 14 that can be used to form the part 10.

However, the addition of the agent 42 reduces the viscosity of the fiber/resin melt 40. Namely, the fiber/resin/agent melt 44 is less viscous than the fiber/resin melt 40. In an exemplary embodiment, the fiber/resin/agent melt 44 has a viscosity that can be about 60% lower than that of the fiber/resin melt 40. Also in an exemplary embodiment, the viscosity of the fiber/resin/agent melt 44 can be about 10% lower than that of the fiber/resin melt 40. Of course, higher and lower viscosity reductions are contemplated.

The reduction in viscosity is advantageously used by the present disclosure to provide additional fibers 14 to the part 10. Specifically, it has been determined that the viscosity increase caused by the addition of the fibers 14 can be offset by introducing the agent 42 (which reduces viscosity) downstream of the fibers. Thus, apparatus 22 is configured to introduce higher volumes of fibers 14 into the part 10 than previously possible.

In prior methods/machines, where the reinforcing agents were part of the resin pellets, the maximum viscosity level of prior extrusion machines was reached at about 30% by weight of the reinforcing agent. Thus, prior extrusion machines are capable of producing parts having about 30% by weight of the reinforcing agent. However, by introducing the fiber 14 and the agent 42 as described above, the apparatus 22 is particularly adapted to produce the part 10 having at least about 10% by weight of the part, with up to about 70% by weight of the fibers preferred and minimum degradation of the fibers. Accordingly, not only does the apparatus 22 produce part 10 having longer fibers 14 than previously possible, but it also produces parts having significantly more fibers by weight incorporated in the part.

Additionally, the apparatus 22 is particularly adapted to produce parts 10 having a maximum number of wetted fibers 18 and a minimum number of un-wetted fibers 20. This is accomplished by controlling the apparatus 22 to adjust, for example, the amount of the fibers 14 fed into the extrusion machine 24, the amount of the agent 42 injected into the sealed section 52, the type of the agent injected into the sealed section, the pressure within the sealed section, the temperature within the sealed section, the pressure drop between the first and second conditions, and combinations of any or all of the foregoing.

By way of example, the apparatus 22 is particularly adapted to produce a part 10 having: a part density of at least about 95% of a non-foamed part, up to about 75%, with about 5% to about 40% preferred; having a cell size of at least about 10 microns, up to about 200 microns; fibers 14 having a length of at least about 25 mm, with up to about 100 mm preferred; and fibers 14 in an amount of at least about 10% by weight of the part, with up to about 70% by weight preferred. In an exemplary embodiment of the part 10, the part has a density of about 0.7 to 0.8 grams per cubic centimeter (g/cc).

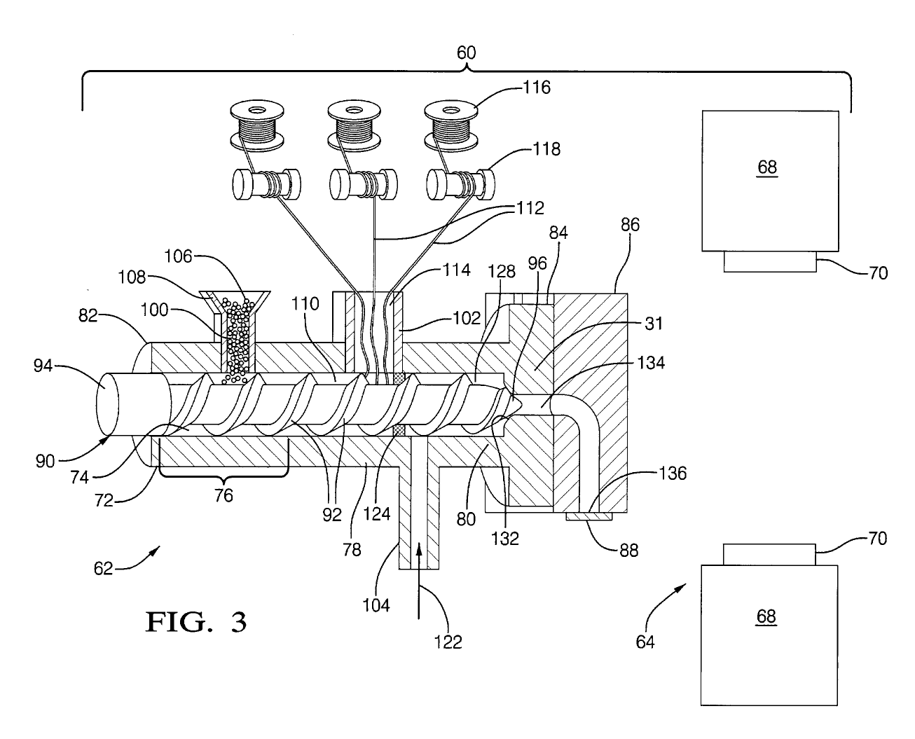

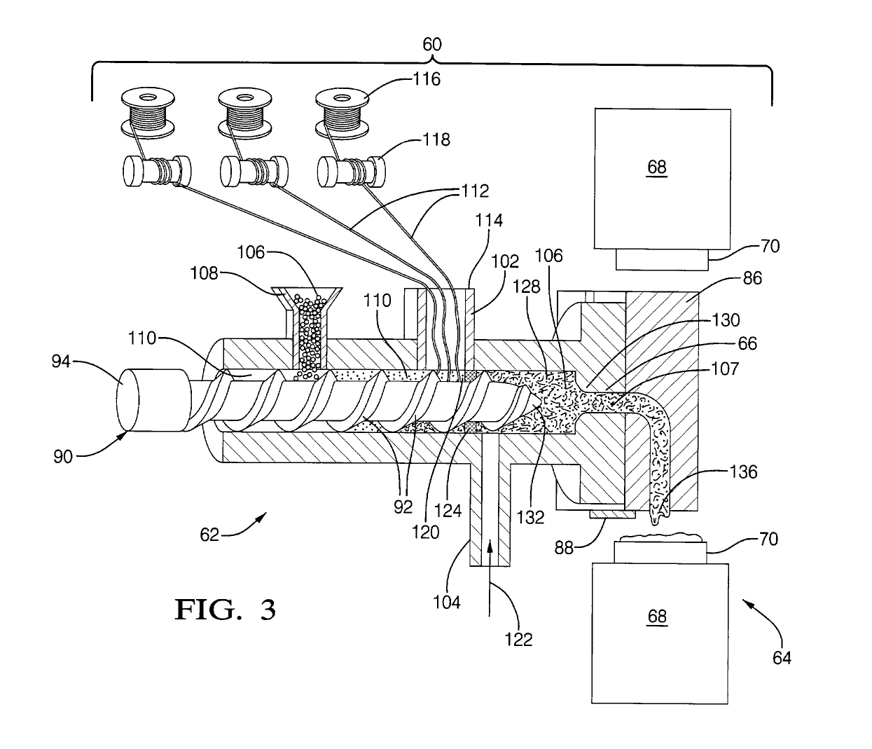

An alternate exemplary embodiment of an apparatus 60 for forming the fiber reinforced part 10 is shown in FIGS. 3 and 4.

As will be described in detail below, the apparatus 60 is configured for the in-line compounding/extrusion followed by deposition and compression molding of the part 10. The apparatus 60 comprises an extrusion machine 62 and a tool 64. The extrusion machine 62 is adapted to produce a fiber/resin/agent melt 66. The extrusion machine 62 is configured for movement with respect to the tool 64 to deposit the melt 66 on the tool. For example, the extrusion machine 62 can be configured to move between a first position (FIG. 3) and a second position (FIG. 4). Of course, the extrusion machine 62 can also be configured to evenly deposit the melt 66 on the tool, such as by moving with respect to the tool in an x-direction, a y-direction and a z-direction.

The tool 64 comprises a press 68 with a mold 70. The mold 70 is configured to produce the part 10 of the desired shape and size. The extrusion machine 62 is further configured to distribute the melt 66 on the mold 70. Specifically, the extrusion machine 62 is adapted to move with respect to the tool 64 to evenly distribute the melt 66 in the mold 70. For example, the extrusion machine 62 is configured to move in at least tow directions with respect to the tool 64, preferably three directions, to evenly distribute the melt 66 in the mold 70. The press 68 is adapted to compress the mold 70 about the melt 66 such that the mold forms the desired part 10 by a compression molding technique.

The extrusion machine 62 comprises a barrel 72 having an internal cavity 74 extending along a longitudinal axis thereof. The internal cavity 74 is generally divided into three zones, namely a first zone 76, a second zone 78, and a third zone 80. Each of the zones 76, 78, 80 performs an operation useful in the compounding/extrusion process as will be described in greater detail hereinafter. It should be understood that the relative size of each of the zones 76, 78, and 80 has been illustrated for purpose of illustration and clarity only and it is contemplated that the lengths of these zones 76, 78, and 80 differ depending upon the application.

The internal cavity 74 extends from the first end 82 to the second end 84 of the barrel 72. Here, the first zone 76 starts at the first end 82. The cavity 74 transitions from the first zone 76 to the second zone 78 down stream of the first end 82. The second zone 78 transitions to the third zone 80, which ends proximate the second end 84. Located at the second end 84 of the barrel 72 is a die 86 including a blade 88. The blade 88 is illustrated at the exit of the die 86 to minimize gas pre-expansion in the die. The blade 88 opens (FIG. 4) and closes (FIG. 3) during operation of the apparatus 60 to allow the melt to exit the die 86.

The die 86 is in fluid communication with the internal cavity 74 at the second end 84 of the barrel 72. The blade 88 is designed to provide the selective fluid communication between the die 86 and the mold 70. In the closed position, the screw 90 is prevented from advancing material from the die 86 (FIG. 3). As a result, material disposed within the internal cavity 74 of the barrel 72 and die 86 is prevented from freely exiting the die or communicating with the mold 70. Thus, when the blade 88 is closed, the rotation of the screw 90 advances and mixes the melt, fiber, and agent so that the melt accumulates in the cavity 74 and die 86 before the blade 88. In the open position, the screw 90 is allowed to advance material from the die 86 (FIG. 4).

The internal cavity 74 is preferably cylindrical in shape and has a diameter great enough to permit a screw 90 to be disposed therein. Preferably, the screw 90 is sized to fit in the internal cavity 74 so as to be rotatably disposed therein. Namely, the widest diameter of the screw 90 is slightly less than the inner diameter of the internal cavity 74. Accordingly, the internal cavity 74 is configured to receive the screw 90 in a manner which allows the screw to rotate therein. The screw 90 includes a plurality of flights 92, a first end 94, a second end 96, and a head 98. The flights 92 are designed to advance the material through the internal cavity 74 as the screw 90 rotates. Namely, the flights 92 at the first end 94 are larger (e.g., deeper) than the flights at the second end 96.

The head 98 is provided at the second end 96 of the screw 90. When the screw 90 is inserted into the internal cavity 74 of the barrel 72, the head 98 is inserted into the internal cavity 74 at the first end 82 of the barrel 72 and is advanced therein towards the opposing second end 84.

The apparatus 60 comprises a first inlet 100, a second inlet 102, and a third inlet 104 disposed at its outer surface. The first, second and third inlets are in fluid communication with the internal cavity 74.

The first inlet 100 comprises a bore extending from the outer surface of the barrel 72 and is substantially perpendicular to the longitudinal axis of the barrel. The first inlet 100 is configured to introduce a thermoplastic resin 106 into the first zone 76 of the internal cavity 74. In the exemplary illustrated embodiment, the first inlet 100 is preferably cylindrical in shape. Of course, the first inlet 100 having other cross-sectional shapes is contemplated.

The diameter of the first inlet 100 is of a sufficient dimension to permit the inlet of thermoplastic resin 106 to be introduced there through into the internal cavity 74. As the thermoplastic resin 106 enters the internal cavity 74, it enters into the first zone 76.

The compression ratio is generally defined as a comparison of the channel depth of the last flight of the first zone and the channel depth of the first flight in the third zone. The channel depth (flight depth) is the distance from the outer edge of a flight 92 to the outer surface of the screw 90. Increasing the compression ratio also increases the heat on the resin 106.

Thus, the screw 90 is designed so that as the thermoplastic resin 106 enters the internal cavity 74 through the first inlet 100, the depth of the plurality of flights 92 of the screw 90 is decreased. By decreasing the depth of the plurality of flights 92, the compression ratio is increased. For example, between the first and second inlets 100, 102 the depth of flights 92 transition quickly from a deep flight depth to a shallow flight depth. The flight depth should be deep enough to create a compression ratio greater than about 3.5:1 in the first zone. In an exemplary embodiment, the compression ratio is preferably about 8:1 to aid in the rapid melting of the incoming thermoplastic resin 106 before it reaches the second inlet 102. In exemplary embodiments, the screw 90 can include double flights or high shear elements to aid in the rapid melting of the incoming thermoplastic resin 106 before it reaches the second inlet 102.

Thus, as the thermoplastic resin 106 is introduced into the internal cavity 74, it contacts the screw 90 and is disposed there around and between the plurality of flights 92 which serves to advance and melt the thermoplastic resin 106 towards the second end 84 as the screw 90 is rotated.

The internal cavity 74 of the barrel 72 is precisely sized to fit the screw 90 and allow a very narrow gap 110 to exist between the outer diameter of the screw 90 (e.g., the flights 92) and the diameter of the internal cavity 74 of the barrel 72. The screw 90 has a preselected diameter (D) and length (L) such that the L/D is large. Preferably, the L/D is greater than or equal to about 16:1, with greater than or equal to about 35:1 more preferred. It is generally known that the higher the L/D ratio, the higher will be the surface available for shearing, mixing, and melting the thermoplastic resin 106. Higher L/D ratios also allow for gentle mixing of the fibers and polymer, without degradation of glass fiber.

The first inlet 100 is designed to receive a hopper 108. The hopper 108 comprises a funnel-like holder capable of holding the thermoplastic resin 106. The thermoplastic resin 106 includes but is not limited to any thermoplastic material suitable for the desired part 10. For example, the thermoplastic material can include polypropylene, engineering thermoplastics such as polyester, nylon, polycarbonate, and TPV and TPE based elastomers, with polypropylene being preferred. In one exemplary embodiment, the thermoplastic resin 106 comprises a quantity of polypropylene pellets that are fed through the hopper 108 and first inlet 100 into the internal cavity 74.

The melting is accomplished by maintaining a predetermined compression ratio of the screw 90 as the thermoplastic resin 106, e.g., plastic pellets, is advanced forward within the internal cavity 74 by the plurality of flights 92.

The second inlet 102, similar to the first inlet 100, comprises a bore extending from the outer surface of the barrel 72. The second inlet 100 is configured to introduce reinforcing fibers 112 into the second zone 78 of the cavity 74. The second inlet 102 is substantially perpendicular to the longitudinal axis of the barrel 72. The second inlet 102 opens into the internal cavity 74 so that the fibers may be introduced thereto from outside of the apparatus 60. In the exemplary illustrated embodiment, the second inlet 102 is preferably cylindrical in shape. However, as can be appreciated, other shapes are contemplated.

The second zone 78 of the cavity is configured to shear and impregnate the fibers 112 with the resin 106. The screw 90 design in this second zone 78 has a deep flight depth however the flight depth throughout the second zone 78 remains constant so that there is zero compression in the second zone 78. In other words, the compression ratio is zero because there is no change in the depth of the flights 92 in the second zone 102. Again, the fiber feed area has deeper flight depths as mentioned above. The actual screw flight depth depends on the number of fibers 112 drawn into the second zone 78 and the type of the thermoplastic resin 106 used. A deep flight depth is necessary in the second zone 78 to accommodate a larger volume of fibers 112. The flight depth should be as high as possible based on the structural integrity of the screw 90, which is dependant on the screw diameter.

The second inlet 102 preferably includes a reinforcing fiber guide 114. The guide 114 comprises any number of guides designed to separate individual reinforcing fibers 112 from one another so that the individual reinforcing fibers do not become entangled with one another as they are drawn into the internal cavity 74. In this example, the fibers 112 are individual fibers, bundles of fibers, and combinations of any of the foregoing. In the example where fibers 112 are bundles of fibers, each bundle is comprised of multiple fibers. Hereinafter, individual fibers and bundles of fibers are collectively referred to as “fibers”. The fibers 112 are formed of any suitable fiber material including but not limited to glass fibers, natural fibers, polyaramid fibers (e.g., Kevlar fibers commercially available from DuPont), carbon fibers, and combinations of any of the foregoing.

For example, the second inlet 102 may be formed so that the guide 114 comprises at least one bore formed in and extending through the second inlet 102, wherein one fiber 112 is received within one bore. Each fiber 112 is drawn into the guide 114 from at least one winding/unwinding reel 116. In an exemplary embodiment, three reels 116 are provided. Here, each reel 116 feeds a fiber 112 into the cavity 74. Of courser; more or less than three reels 116 feeding more than one fiber 112 are contemplated.

The guide 114 is useful in directing the fibers 112 into the proper location in the internal cavity 74 and works in conjunction with the winding/unwinding reels 116 to keep the fibers 112 in a constant taut state. In the exemplary embodiment shown, the guide 114 comprises a rotatable member having a plurality of grooves formed therein for separating individual fibers 112 from one another so that the individual fibers 112 do not become entangled during the feeding process.

The reels 116 are preferably located above the guide 114 and are drawn from an equal number of spools 118 containing the fibers 112. While the exemplary embodiment shows the spools 118 as having a round shape, it is understood that the other shapes may be used. There is one spool 118 feeding each reel 116. The movement of the apparatus 60 and the screw 90 sets in motion the winding and unwinding of the fibers 112 on the reels 116.

For example, the rotation of the screw 90 draws the fibers 112 from the reels 116, through the guide 114, and into the internal cavity 74. The unwinding of the fibers 112 from the reels 116 results in the accompanying unwinding from the associated spools 118. Additionally, the movement of the barrel 72 with respect to the reels 116 (e.g., movement of the extrusion machine 62 towards the tool 64) also results in the accompanying unwinding from the associated spools 118. However, when this movement is reversed (e.g., movement of the extrusion machine 62 away from the tool 64) the reels 116 wind the fibers 112 so as not to allow for any slack in the fibers 112. Thus, the fibers 112 are consistently under tension regardless of the positioning of the extrusion machine 62 with respect to the tool 64.

The movement of the winding/unwinding reels 116 can be generated by a servo-driven motor (not shown) or by pre-tension created by spring loading the reel 116 or any other mechanical means. For example, the servo-driven motor is controlled to unwind or wind the reinforcing fiber bundles 112 depending upon the relative position of the extrusion machine 62 with respect to the reel 116.

As the fibers 112 pass from the guide 114 into the internal cavity 74, the fibers 112 are opened for proper melt impregnation. Specifically, the fibers 112 are opened by the guide for better wetting so that each fiber can be wetted or coated with the melted thermoplastic resin 106. It is also understood that pre-heating the fibers 112 after the fiber pass the winding/unwinding reels 116 but prior to entrance into the second inlet 102 is contemplated. This results in increased wetability of the fibers 112 with the melted thermoplastic resin 106. The fibers can also be pretreated (heat and/or tension) as discussed earlier for improved wetting.

In the second zone 78, the fibers 112 are sheared or broken to a desirable length. The shearing is accomplished as the tensile load on the fibers 112 is increased so that each of the fibers 112 shears in approximately the same length. As the fibers 112 move through the second zone 78, the resistance on the fibers 112 increases so that when the resistance becomes too great, the fibers 112 are sheared or broken forming individual sheared reinforcing fibers 107. This is achieved by proper design of the screw.

By drawing the fibers 112 into the extrusion machine 62, the fibers 112 are provided at a greater length than previously possible. For example in a first exemplary embodiment, the extrusion machine 62 is configured to provide fibers 112 having a length of at least 25 mm. In an alternate embodiment, the extrusion machine 62 is configured to provide fibers 112 having a length up to about 100 mm. By way of comparison, prior methods of feeding reinforcing fibers incorporated into the resin pellets provided fibers having a maximum length of about 8 mm.

The fibers 112 are mixed with the molten and/or semi-molten thermoplastic resin 106 such that the fibers are dispersed in the molten resin to form a fiber/resin melt 120. Due to the tension on the fibers 112 as they are drawn into the thermoplastic resin 106, the reinforcing fibers are axially oriented along a common direction (e.g., along the axis of the barrel 72). Thus, the apparatus 60 can be configured to produce part 10 having the fibers substantially aligned in one direction (e.g., non-isotropic parts). Namely, the geometry of the die 86 can be configured such that non-isotropic parts are produced.

The third inlet 104 is configured to introduce a blowing agent 122 into the third zone 80 of the cavity 74. Similar to the first and second inlets, the third inlet 104 comprises a bore extending from the outer surface of the barrel 72. The third inlet 104 is substantially perpendicular to the longitudinal axis of the barrel 72, preferably on the top of the barrel. The third inlet 104 opens into the internal cavity 74 so that the agent 122 may be introduced thereto from outside of the apparatus 60. Thus, the cavity 74 is a closed system where the agent is added therein. In the exemplary illustrated embodiment, the third inlet 104 is preferably cylindrical in shape. The third inlet 104 is positioned down stream of the second inlet 102. The first inlet 100 is thus closer to the first end 82 of the barrel 72 than the second inlet 102, while the third inlet 104 is closer to the second end 84 of the barrel 72 than the second inlet 102.

The apparatus 60 further comprises a sealing element 124 and an inlet valve 126. The sealing element 104 seals the barrel 72 prior to the third inlet 104. Similarly, the inlet valve 126 seals the barrel 72 at the third inlet 104. The blade 88 seals the die 86 provide selective fluid communication with the mold 70. Thus, a sealed section 128 of the barrel 72 is formed.

The blowing agent 122 is introduced into the sealed section 128 by opening the inlet valve 126. The sealing element 124 is configured to permit the flow of the fiber/resin melt 120 into the sealed section 128. However, the element 124 is also configured to prevent the flow of the agent 122 back towards the first and second inlets 100 and 102. The screw 90 is configured to admix the fiber/resin melt 120 with the blowing agent 122 to form a fiber/resin/agent melt 66. The sealed section 128 is maintained at first conditions sufficient to maintain the blowing agent 122 in a liquid form.

After the agent 122 is injected into the fiber/resin melt 120, the inlet valve 126 is closed. The screw 90 admixes the liquid blowing agent 122 such that the fiber/resin/agent melt 66 is a substantially homogeneous mixture of the blowing agent in the melt. The fiber/resin/agent melt 66 is maintained at the first conditions until the formation of the cells 12 is desired.

The continued rotation of the screw 90 advances the melt 66 towards the head 98 of the screw. In addition to being rotatable, the screw 90 can also be configured to reciprocate within the cavity 74. Namely, the continued rotation of the screw 90 advances the melt 66 until a shot 130 accumulates in the cavity 74 and die 86 between the head 98 and the blade 88. The accumulation of the shot 130 causes the screw 90 to retract or move the head 98 away from the second end 84 of the barrel 72 (FIG. 4).

In order to force the melt 66 from the cavity 74, the blade 88 is opened and the screw 90 is moved forward until the head 98 of the screw abuts a beveled portion 132 of the barrel 72. The beveled portion 132 has a shape complementary to the head 98 so that the beveled portion acts as a stop for the screw 90 as the screw is driven in a direction towards the second end 84. The beveled portion 132 includes and defines a central opening 134 in fluid communication with the die 86. Thus, the shot 130 is forced from the barrel 72 by opening the blade 88 and moving the blade 88 forward until the head 98 abuts the beveled portion 132.

In this manner, the screw 90 urges the melt 66 through the die 86 and out of the die at its exit port 136. As discussed above, the extrusion machine 62 is configured to move with respect to the tool 64. Specifically, the extrusion machine 62 moves with respect to the tool 64 so that the exit port 136 evenly distributes the melt 66 on the mold 70. The reciprocation of the screw 90 allows for the deposition of the melt on the mold 70.

Not shown is the means by which the rotation and reciprocation of the screw 90 is accomplished. Any conventional means can be utilized. Here, the speed of rotation of the screw 90 is dependant on the type of thermoplastic resin 106, the amount of the cut reinforcing fibers 107, and blowing agent 122 in the melt 66.

Once the formation of the cells 12 is desired, the first conditions will be adjusted to second conditions. The second conditions are sufficient to convert the agent 122 from the liquid form a gas (e.g., the pressure is reduced). The gaseous agent 122 expands and forms bubbles in the melt 66 to form the cells 12. This change in conditions (from the first to the second condition) changes the blowing agent to a gas by subjecting the mixture to for example, a rapid change in temperature, a rapid change in pressure, or combinations thereof. The change from the first to the second conditions can occur at a desired location in the apparatus 60. In an exemplary embodiment, the change from the first to the second conditions occurs as the melt 66 is urged from the cavity 74 onto the mold 70. Namely, the first conditions are be adjusted to second conditions in the third zone.

The addition of the fibers 112 increases the viscosity of the fiber/resin melt 120. The extrusion machine 62 typically has a maximum viscosity level beyond which it can no longer function effectively. This maximum viscosity level sets a limit on the total amount of fibers 112 that can be introduced to the extrusion machine 62. Thus, this maximum viscosity level sets a limit on the total amount of fibers 112 that can be used to form the part 10.

However, the addition of the agent 122 reduces the viscosity of the fiber/resin melt 120. Namely, the fiber/resin/agent melt 66 has a viscosity that is lower than that of the fiber/resin melt 120. In an exemplary embodiment, the viscosity of the fiber/resin/agent melt 66 is lower than that of the fiber/resin melt 120 by preferably greater than or equal to about 10%, with about 60% more preferred. Of course, higher and lower viscosity reductions are contemplated.

The reduction in viscosity is advantageously used by the present disclosure to provide additional fibers 112 to the part 10. Specifically, it has been determined that the viscosity increase caused by the addition of the fibers 112 can be offset by introducing the agent 122 (which reduces viscosity) downstream of the fibers. Thus, apparatus 60 is configured to introduce higher volumes of fibers 112 into the part 10 than previously possible.

When the reinforcing agents were introduced as part of the resin pellets, the maximum viscosity level of prior extrusion machines was reached at about 30% by weight of the reinforcing agent. Thus, prior extrusion machines are capable of producing parts having about 30% by weight of the reinforcing agent. However, by introducing the fibers 112 and the agent 122 as described above, the apparatus 60 is particularly adapted to produce the part 10 having at least about 10% by weight of the part, up to about 70% by weight of the fibers. Accordingly, not only does the apparatus 60 produce part 10 having longer fibers 112 than previously possible, but it also produces parts having significantly more fibers by weight incorporated in the part.

It should be recognized that apparatuses 10 and 60 are illustrated above by way of example only, other extrusion machines capable of in line compounding of thermoplastic resins with fibers, followed by formation of the cells 12 are contemplated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A foamed thermoplastic resin fiber reinforced part, comprising:
a member formed of thermoplastic resin;
a plurality of cells and a plurality of reinforcing fibers dispersed within said member; and
a skin formed on at least one exterior surface of said member, said skin being substantially devoid of said cells, said reinforcing fibers having a length of at least about 25 mm, said reinforcing fibers comprising an amount of at least about 10% by weight of said foamed thermoplastic resin fiber reinforced part, wherein at least one of a cell density and a cell size of said plurality of cells is inversely proportional to said amount of said reinforcing fibers dispersed within said member.

2. The part as in claim 1, wherein said reinforcing fibers have a length of less than about 100 mm.

3. The part as in claim 2, wherein said amount is less than about 70% by weight of said foamed thermoplastic resin fiber reinforced part.

4. The part as in claim 1, wherein said reinforcing fibers are selected from the group consisting of glass fibers, natural fibers, polyaramid fibers, carbon fibers, and combinations of any of the foregoing.

5. The part as in claim 4, wherein said reinforcing fibers comprise individual fibers, bundles of fibers, continuous fibers, chopped fibers, and combinations of one or more of any of the foregoing.

6. The part as in claim 1, wherein a portion of said reinforcing fibers are randomly oriented within said member to impart isotropic properties to said foamed thermoplastic resin fiber reinforced part.

7. The part as in claim 1, wherein a portion of said reinforcing fibers are oriented within said member to impart non-isotropic properties to said foamed thermoplastic resin fiber reinforced part.

8. The part as in claim 3, wherein said cell density is about is about 5 percent to about 40 percent of a non-foamed part.

9. The part as in claim 8, wherein said cell size is about 10 microns to about 200 microns.

10. The part as in claim 1, wherein said thermoplastic resin is selected from the group consisting of polypropylene, engineering thermoplastics, polyester, nylon, polycarbonate, TPV based elastomers, TPE based elastomers, and combinations of any of the foregoing.

11. An apparatus for producing a foamed fiber reinforced part, the apparatus comprising:
a barrel having an internal cavity formed therein;
a first inlet for feeding a thermoplastic material into said internal cavity;
a second inlet downstream of said first inlet, said second inlet feeding reinforcing fibers into said internal cavity, said second inlet having at least one tensioning reel for feeding said reinforcing fibers under a constant tension;
a third inlet downstream of said second inlet, said third inlet for selectively injecting a blowing agent into said internal cavity; and
a screw rotatably disposed within said internal cavity of said barrel such that a first zone, a second zone, and a third zone of said barrel are defined,
said first zone being configured for melting of said thermoplastic material, said second zone being configured for shearing said reinforcing fibers to a predetermined length, said second zone being configured to form a first melt from said thermoplastic material and said reinforcing fibers, and said third zone forming a second melt from said first melt and said blowing agent,
said third zone being configured to maintain said second melt at a first condition sufficient to maintain said blowing agent in a desired form, said second melt being exposed to a second condition sufficient to cause said blowing agent to form cells in said second melt when said second melt is forced from said internal cavity.

12. The apparatus as in claim 11, wherein said blowing agent reduces a viscosity of said second melt as compared to said first melt.

13. The apparatus as in claim 11, wherein said screw is retractable by a shot of said second melt as said shot accumulates at a head of said screw, and said screw being extendable to force said shot from said barrel into a mold.

14. The apparatus as in claim 11, wherein a sealing element seals said third zone such that said blowing agent is sealed from said second zone.

15. The apparatus as in claim 11, wherein said screw is accumulates a shot of said second melt in a plunger, said plunger being extendable to force said shot into a mold.

16. The apparatus as in claim 11, wherein rotation of said screw draws said reinforcing fibers into said second zone under said constant tension.

17. The apparatus as in claim 11, wherein said second zone is configured to shear said reinforcing fibers to a length of about 25 mm to about 100 mm, and being configured to introduce said reinforcing fibers in said amount of about 10% by weight to about 70% by weight.

18. The apparatus as in claim 17, wherein said reinforcing fibers are selected from the group consisting of glass fibers, natural fibers, polyaramid fibers, carbon fibers, and combinations of any of the foregoing.

19. The apparatus as in claim 18, wherein said reinforcing fibers comprise individual fibers, bundles of fibers, continuous fibers, chopped fibers, and combinations of one or more of any of the foregoing.

20. The apparatus as in claim 11, wherein said blowing agent is selected from the group consisting of physical blowing agents, chemical blowing agents, supercritical fluids, and combinations of any of the foregoing

21. An apparatus for producing a foamed fiber reinforced part, comprising:
an extrusion machine comprising a twin-screw extruder, said twin-screw extruder being in fluid communication with a first inlet, a second inlet, and a third inlet, said second inlet being intermediate said first and third inlets, said first inlet being configured to introduce a thermoplastic resin to said twin-screw extruder, said second inlet being configured to introduce reinforcing fibers to said twin-screw extruder, said twin-screw extruder being configured to form a first melt from said thermoplastic resin and said reinforcing fibers;
a sealed section defined in said extrusion machine, said sealed section being defined at said third inlet, said third inlet being configured to inject a blowing agent into said sealed section, said twin-screw extruder being configured to form a second melt from said first melt and said blowing agent, said sealed section maintaining said blowing agent at a first condition; and
an injection machine in fluid communication with an output of said extrusion machine, said injection machine being configured to receive said second melt from said sealed section, said injection machine being configured to inject said second melt into a mold, said injection machine being configured to change said first conditions to second conditions when said second melt is injected into said mold, said second conditions being sufficient to cause said blowing agent to form a plurality of cells in said second melt, and said mold being configured to form said second melt into a part.

22. The apparatus as in claim 21, wherein said second inlet is configured to introduce said reinforcing fibers to said twin-screw extruder having a length of about 25 mm to about 100 mm, and being configured to introduce said reinforcing fibers in said amount of about 10% by weight of said part to about 70% by weight of said part.

23. The apparatus as in claim 22, wherein said reinforcing fibers are selected from the group consisting of glass fibers, natural fibers, polyaramid fibers, carbon fibers, and combinations of any of the foregoing.

24. The apparatus as in claim 23, wherein said reinforcing fibers comprise individual fibers, bundles of fibers, continuous fibers, chopped fibers, and combinations of one or more of any of the foregoing.

25. The apparatus as in claim 21, wherein said extrusion machine is configured such that at least a portion of said reinforcing fibers are randomly oriented within said part to impart isotropic properties to said part.

26. The apparatus as in claim 21, wherein said extrusion machine is configured such that at least a portion of said reinforcing fibers are oriented within said part to impart non-isotropic properties to said part.

27. The apparatus as in claim 21, wherein said blowing agent is selected from the group consisting of physical blowing agents, chemical blowing agents, supercritical fluids, and combinations of any of the foregoing.
